(19) United States
(12) Patent Application Publication
(10) Pub. No.: US 2013/0093141 A1
(43) Pub. Date: Apr. 18, 2013

(54) Weather Strip Seal for an Automotive Vehicle, and its Manufacturing Method

(71) Applicant: André Guellec, Bloomfield, MI (US)

(72) Inventor: André Guellec, Bloomfield, MI (US)

(73) Assignee: HUTCHINSON SEALING SYSTEMS, Auburn Hills, MI (US)

(21) Appl. No.: 13/614,553

(22) Filed: Sep. 13, 2012

Related U.S. Application Data
(60) Provisional application No. 61/540,908, filed on Sep. 29, 2011.

(51) Int. Cl. B60J 10/04; B23P 17/00

(52) U.S. Cl. 277/637; 29/428

(57) ABSTRACT

The invention provides a weather strip seal for an automotive vehicle which is provided for sealing between a first structure and a second structure made of a vehicle framework having a flange protruding from an adjacent framework surface, and to a method for manufacturing such a strip seal. The weather strip seal includes a clamping means for clamping on the flange comprising an outer clamping portion having a first branch and a second branch and an inner clamping portion incorporating separate gripping clips mounted along the length of and against said outer clamping portion by an outer part of each clip, and in contact with the flange by inner gripping means of each clip, a first sealing portion sealingly presses against said first structure and which extends from said first branch, and a second sealing portion presses against said adjacent framework surface and extending on said second branch.

### FIELD OF THE INVENTION

The present invention relates to a weather strip seal for an automotive vehicle which is provided for sealing between a first structure and a second structure, and to a method for manufacturing such a strip seal. In particular, the invention may advantageously concern an outer belt strip seal for an automobile vehicle.

### BACKGROUND OF THE INVENTION

All automotive vehicles have movable and/or fixed windows in their side doors, there being a requirement for various designs of weather strip seals to seal gaps between two body panel structures, such as a window pane and a door framework defining a flange onto which such a seal is clamped.

Existing flange-mounted weather strip seals for outer belt or waist seals can be designed either with grippers being part of the main body of the extruded or injection molded seal, or with post-applied grippers/locators (by “grippers” and “locators”, it is referred in a known way to retaining means for gripping the flange and for correctly positioning the seal in the cross-direction Y of the vehicle).

Post-applied grippers/locators can be made of polymeric materials (either soft or rather rigid), or of metal materials in the case of metal clips inserted inside and against the main body of the seal clamping portion. Specifically, outer belt strip seals may usually be classified into the three following main families.

A first family relates to outer belt seals extruded onto a metal core, with the grippers/locators being co-extruded over the entire length of the main body of the seal, or being made of a plurality of post-applied grippers or clips spaced along this length. The selected type of these grippers/locators may depend on parameters such as the strip seal height and width dictated by the automobile constructor designers, the optional presence of “cross and up/down sweep” on the door requiring an additional processing step on the seal (called “stretch-bending” operation) to adapt the outer belt assembly to its future environment, and the shape of the seal ends dictated by the automobile constructor (e.g. molded ends, formed ends or post-applied end caps).

A second family relates to outer belt seals extruded without any metal core (such seals are often said to be “unsupported”). The seal clamping portion is usually designed with a rigid material (e.g. based on polypropylene) whereas the sealing and gripping means are made of a more flexible material (e.g. a thermoplastic elastomer or a plastomer). In most cases, the gripping means are co-extruded but, as visible in FIG. 1 which is enclosed herewith and shows an outer belt strip seal 1 of the prior art with a sealing lip 2 pressing against a side window pane 3, these gripping means 4 may alternatively be post-applied inside and against the seal clamping portion 5. These gripping means 4 of FIG. 1 are made of polymeric retaining profiles 4 which are post-applied in a few local areas along the length of the clamping portion 5 and which have lips 4a adapted to grip the corresponding flange 6a of the door frame 6.

A third family relates to molded outer belts seals (either bi-injected or molded over a plastic insert) having gripping means which, in order not to hinder the molding process, are usually not formed integrally with the inner face of the seal clamping portion so as to be free of die lock features. FIGS. 2 and 3 enclosed herewith both show an example of such gripping means 14 for a molded outer belt seal 11 which consist of spaced post-applied clips 14 being either metallic or made of a rather rigid plastic material, such as a polyamide (e.g. PA 6.6). Each clip 14 is usually hooked by its inner leg 14a to the inboard branch 15a of the seal clamping portion 15 and ensure the cross-directional location of the mounted seal 11 as well as its retention on the flange 16a by two gripping lips 14c obliquely projecting from an outer leg 14b in contact with the outboard branch 15b of this clamping portion 15.

As visible in FIG. 2 which shows a nominal thickness of the flange 16a, the rigid gripping lips 14c flex in operation so as to maintain the seal 11 in its intended designed location. But as visible in FIG. 3 which shows the maximum thickness for this flange 16a, these rigid gripping lips 14c are not flexible enough to precisely follow such a variation of the flange thickness by keeping the outer sealing portion 17 extending beyond the outer branch 15b in contact with the curved frame surface 16b adjacent the flange 16a, which makes the seal outer part 16b, 17 be distant from this surface 16b thus creating a major appearance defect (see the encircled zone in FIG. 3).

In other words, a major drawback of known post-applied spaced gripping clips for such outer belt seals resides in their not being able to accommodate large variations of the fastening flange thickness.

Document WO-A2-2009/136111 discloses an outer belt strip seal comprising a single longitudinal gripping profile which is attached to a rigid molded clamping portion and which comprises a gripping lip for mounting on the frame flange. This gripping profile incorporates an integrally formed sealing lip for pressing against the window panel, and is made of extruded flexible materials respectively for both this gripping sealing lips and for the rest of the profile.

### OBJECTS AND SUMMARY OF THE INVENTION

It is an object of the present invention to provide a weather strip seal for a motor vehicle, which is usable to form an outer belt or waist seal and remedies the aforementioned drawback for this seal which does not accommodate large variations of the fastening flange thickness.

It is also an object of the present invention to provide such a weather strip seal which is located and robustly retained in an improved manner on this flange.

It is further an object of the present invention to provide a manufacturing method for such a strip seal which is easily implemented and thus involves a relatively reduced manufacturing cost for this strip seal.

A weather strip seal for an automotive vehicle of the invention, which is provided for sealing between a first structure and a second structure consisting of a vehicle framework having a flange protruding from an adjacent framework surface, comprises:

a clamping means for clamping on said flange, said clamping means comprising an outer clamping portion having a first branch and a second branch defining together a substantially U-shaped cross-section, and an inner clamping portion incorporating a plurality of separate gripping clips mounted in a spaced relationship along the length of and against said outer clamping portion by an outer part of each clip, and in contact with said flange by inner gripping means of each clip,

a first sealing portion which is designed to sealingly press against said first structure and which extends from said first branch, and

a second sealing portion which is designed to sealingly press against said adjacent framework surface and which extends on said second branch.

To achieve all the above-recited objects in this strip seal of the invention, each of said gripping clips is made of one piece of different materials comprising, for said outer part, at least one rigid material and, for said inner gripping means, at least one flexible polymeric material.

According to a first embodiment of the invention, said at least one rigid material is based on at least one thermoplastic polymer of the plastomer type, said at least one flexible material being based on at least one elastomer or plastomer, so that each of said gripping clips is entirely polymeric.

According to another aspect of this first embodiment, said at least one rigid material may exhibit a Shore D durometer higher than 30 and preferably higher than 60, whereas said at least one flexible material may exhibit a Shore A durometer higher than 30 and preferably of between 50 and 90.

Also preferably in said first embodiment, said at least one rigid material is based on a polyolefin which is preferably polypropylene, said at least one flexible material being based on a thermoplastic elastomer which is preferably a thermoplastic vulcanizate (TPV).

According to a second embodiment of the invention, said at least one rigid material is based on a metallic material, said at least one flexible material being based on at least one elastomer or plastomer, so that each of said gripping clips is a composite of metallic and polymeric materials.

According to a preferred embodiment of the invention which may refer either to said first embodiment or to said second embodiment, each of said clips has:

said outer part which substantially exhibits a S-shaped cross-section with a first median leg ending in at least one hook member receiving and hooking onto an end member of said first branch for fastening each clip to it, and with a second leg substantially parallel to said first leg and having an inner surface, and

said inner gripping means which comprise at least one and preferably two gripping lip(s) obliquely extending from said inner surface of said second leg for gripping a facing surface of said flange.

Advantageously, each of said clips may have two said hook members connected together by a notch, and a tongue which faces said notch may resiliently project from an inner surface of said first leg to press against said flange opposite said facing surface thereof. Alternatively, each of said clips may be co-extruded and have only one said hook member which is continuous (i.e. with no such notch being formed), which may be the case either for each polymeric clip of said first embodiment or for each partly metallic clip of said second embodiment.

According to another feature of the invention, said first sealing portion may comprise at least one primary sealing flocked lip which obliquely extends from said first branch and terminates in a secondary lip directed toward said first branch, and said second sealing portion may continuously cover an outer face of said second branch and extend beyond both ends thereof by forming an upper lip which faces said secondary lip and a lower lip designed to sealingly press against said adjacent framework surface.

Advantageously, said first and second sealing portions may be both made of at least one flexible material which is preferably the same as that of said inner gripping means and which preferably is an elastomeric material based on a thermoplastic vulcanizate (TPV).

In a variant embodiment, said first and second sealing portions may be based on at least one elastomer selected from the group consisting of ethylene-propylene-diene rubbers (EPDM) and thermoplastic elastomers (TPE) other than TPVs, such as styrene block thermoplastic elastomers (TPS).

According to a preferred embodiment of the invention relating to any of the aforementioned features, said weather strip seal forms an outer belt strip seal, said first structure being a side window pane of said vehicle and said second structure being a door frame outside said window pane.

Also advantageously, said outer clamping portion may be devoid of any metal core.

The method of the invention for manufacturing said weather strip seal comprises the following steps:

a) forming in one piece said outer clamping portion and said first and second sealing portions,

b) forming in one piece each of said gripping clips, then

c) applying said gripping clips in a spaced relationship inside and along the length of said outer clamping portion.

According to another feature of the invention, step b) may be carried out by one of the following techniques:

bi-injection molding in a single mold said at least one rigid material and said at least one flexible material,

over-molding said at least one flexible material by injection over said at least one rigid material, preferably in two molds, or

co-extruding said at least one flexible material and said at least one rigid material.

According to said first embodiment of the invention, step b) may be for instance carried out by co-extruding said at least one flexible material, such as a thermoplastic one, with said at least one rigid material which is based on at least one plastomer, such as polypropylene.

According to said second embodiment of the invention, step b) may be carried out by co-extruding said at least one flexible material, such as one based on a thermoplastic polymer (e.g. PVC) or on EPDM, for instance, with said at least one rigid material which is based on a metallic material (e.g. steel, stainless steel or aluminum).

### BRIEF DESCRIPTION OF THE DRAWINGS

Other advantages, characteristics, and details of the invention appear from the following additional description with reference to the accompanying drawings, given purely by way of example, and in which:

FIG. 1 is a cross-sectional view of an outer belt strip seal for a side window of a motor vehicle of the prior art, which incorporates an inner post-applied gripping profile.

FIGS. 2 and 3 are cross-sectional views of another outer belt strip seal for a side window of a motor vehicle of the prior art, which incorporates a plurality of inner post-applied gripping clips made of a single metal or plastic material, FIG. 2 showing a nominal thickness of the door flange receiving the seal and FIG. 3 a maximum thickness for this flange.

FIGS. 4 and 5 are cross-sectional views of an exemplary outer belt strip seal for a side window of a motor vehicle of the invention, which incorporates a plurality of inner post-applied gripping clips made of different materials, FIG. 4 showing a nominal thickness of the door flange receiving the seal and FIG. 5 a maximum thickness for this flange.

FIG. 6 is a perspective view of the gripping clip visible in FIGS. 4 and 5, according to a preferred embodiment of the invention.

FIG. 7 is a partial perspective view showing the inner part of the seal of FIGS. 4 and 5 incorporating several clips such as that of FIG. 6.

FIGS. 8 and 9 are both partial perspective views showing the weather strip seal of FIG. 7 from different angles.

FIG. 10 is a global perspective view showing the weather strip seal of FIGS. 7-9 from still another angle.

FIG. 11 is a cross-sectional view of an outer belt strip seal according to a first variant embodiment of the invention compared to the embodiment of FIG. 4.

FIG. 12 is a cross-sectional view of the co-extruded polymeric gripping clip visible in FIG. 11.

FIG. 13 is a perspective view of the clip of FIG. 12.

FIG. 14 is a cross-sectional view of an outer belt strip seal according to a second variant embodiment of the invention compared to the embodiment of FIG. 4.

FIG. 15 is a cross-sectional view of the co-extruded composite gripping clip visible in FIG. 14.

FIG. 16 is a perspective view of the clip of FIG. 15.

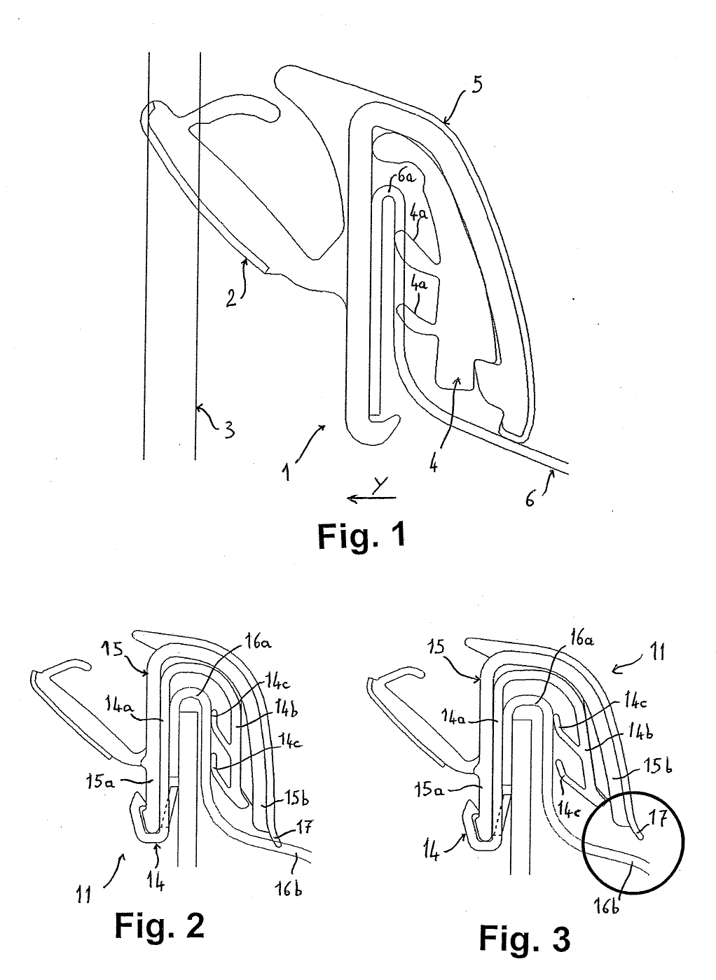

### MORE DETAILED DESCRIPTION

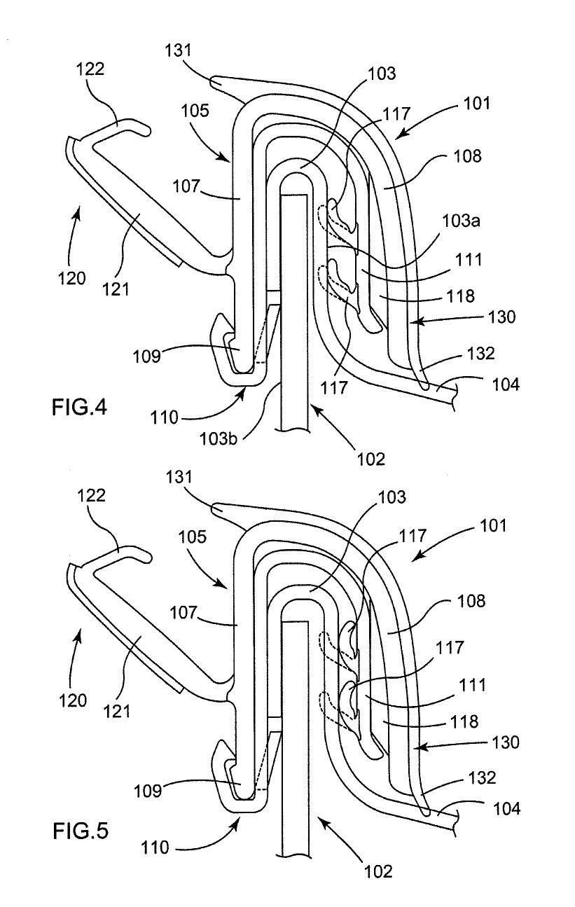

The weather strip seal 101 of FIGS. 4 and 5 is for an outer belt of a side door (either a front or rear door) of an automotive vehicle. This strip seal 101 of the invention is provided for sealing between a window pane of the vehicle and a door frame 102 outside the window pane having a flange 103 protruding from an adjacent framework surface 104, and comprises:

a carrier 105 free of metal core for clamping on the flange 103 comprising:
an outer clamping portion having a first inboard branch 107 and a second outboard branch 108 defining together a substantially U-shaped cross-section, both branches 107 and 108 being made of a rigid thermoplastic material (e.g. a polypropylene-based material), and
a plurality of separate polymeric inner gripping clips 110 mounted in a spaced manner along the length of and against the branches 107, 108 by an outer part 111 of each clip 110, which is in contact with the flange 103 by at least one and preferably two inner oblique gripping lips 117 integrally formed with the outer part 111,

a first sealing portion 120 for example based on a TPV (preferably of a Shore A durometer of between 50 and 90) for sealingly pressing against the window pane with a primary sealing flocked lip 121 which obliquely extends from the inboard branch 107 and ends in a secondary lip 122 directed toward this branch 107, and

a second sealing portion 130 for example also based on such a TPV which is designed to sealingly press against the adjacent framework surface 104 and which continuously covers an outer face of the outboard branch 108 and extends beyond both ends thereof by forming an upper lip 131 which faces the secondary lip 122 and a lower lip 132 designed to sealingly press against this surface 104.

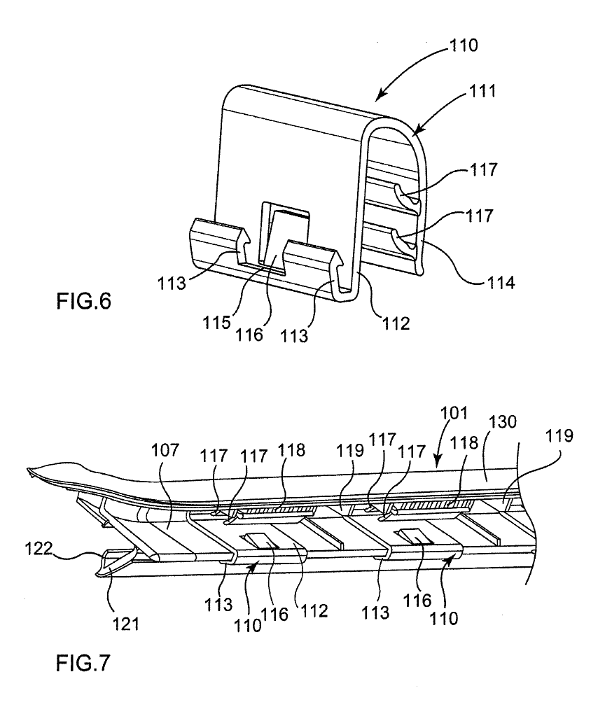

More precisely and as also visible in FIG. 6, the outer part 111 of each clip 110 substantially exhibits a S-shaped cross-section with a first median leg 112 ending in two curved hook members 113 receiving and hooking onto a harpoon-shaped end member 109 (visible in FIGS. 4 and 5) of the inboard branch 107, for fastening each clip 110 to the carrier 105, and with a second outer leg 114 substantially parallel (i.e. parallel or nearly parallel) to the first leg 112 and from an inner surface of which obliquely extend both lips 117 for gripping a facing surface 103a of the flange 103. Both hook members 113 are connected together by a notch 115, and a rectangular tongue 116 which faces the notch 115 resiliently projects from an inner surface of the first leg 112 to press against another surface 103b of the flange 103 which is opposite the facing surface 103a thereof (both flange surfaces 103a and 103b are visible in FIG. 4).

Specifically, each gripping clip 110 visible in FIGS. 4 to 6 is made of one piece of two polymeric-based materials which exhibit different hardness values and which comprise:

for its outer part 111, a rigid material having a Shore D durometer preferably of between 60 and 80 such as a plastic material based on a plastomer (e.g. a polypropylene-based one) and,

for said inner gripping lips 117, a flexible material having a Shore A durometer preferably of about 65 such as an elastomeric material based on a TPV which may advantageously be the same as that used for both first and second sealing portions 120 and 130.

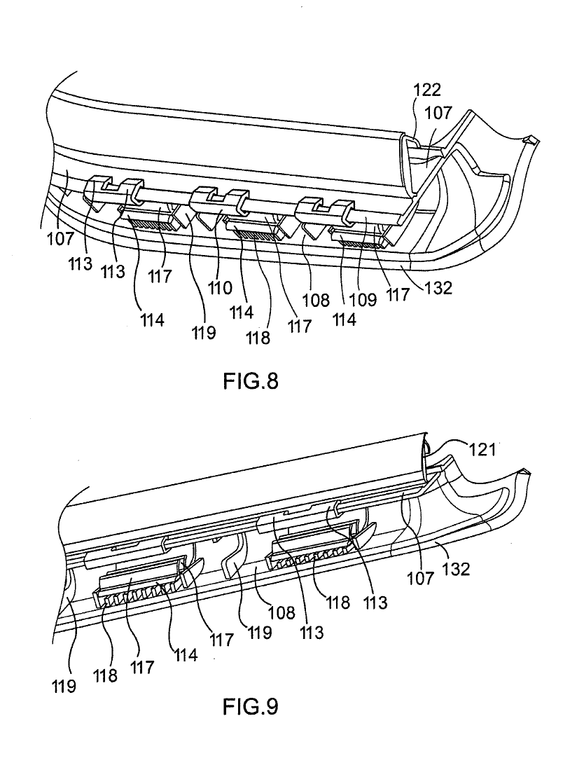

As visible in FIGS. 4 and 5 and also in FIGS. 7 to 9, the outer leg 114 of each clip 110 presses against small spaced protruding members 118 vertically extending on the inner face of the outboard branch 108 of the outer clamping portion 107, 108, whereas (see FIGS. 7-9) wider protruding members 119 designed to increase the rigidity of carrier 105 are provided therein.

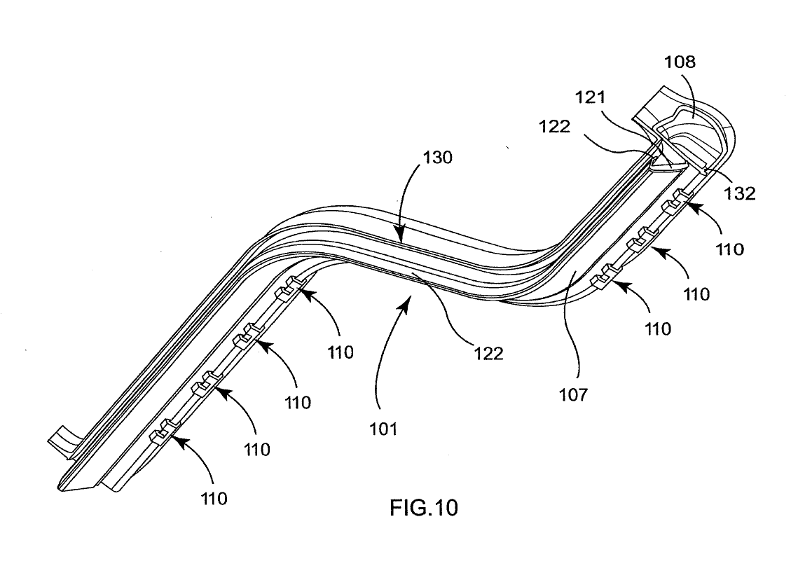

As visible in FIGS. 7-10, the gripping clips 110, which preferably are each obtained in one piece by bi-injection molding in a single mold of this rigid plastic material to form the outer part 111 and of this flexible material to form the gripping lips 117, are inserted and fastened to the outer clamping portion 107, 108 (which may be extruded or molded) in a spaced relationship inside and along the length of this portion 107, 108 with the aforementioned attachment between the hook members 113 of each clip 110 and the end member 109 of the inboard branch 107.

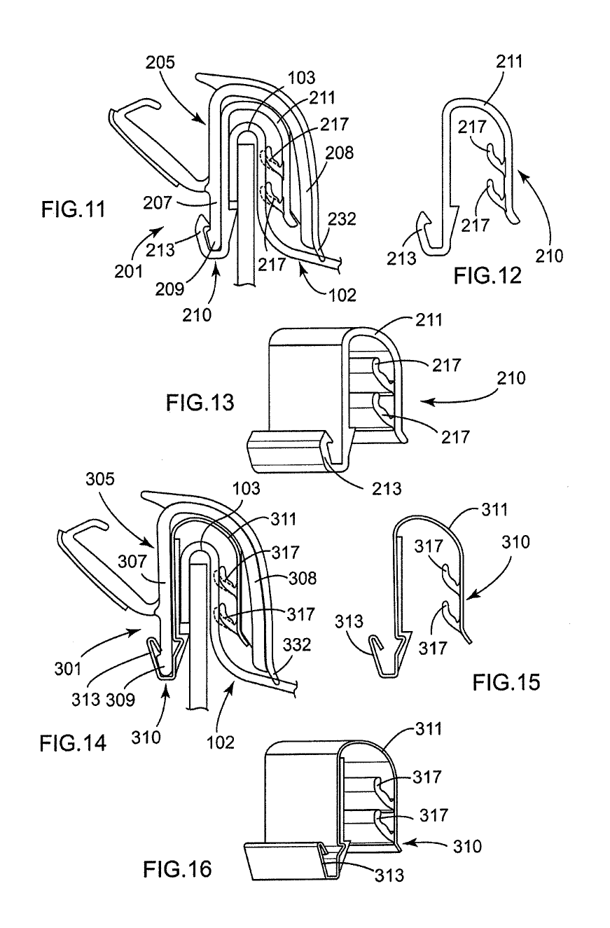

In the first variant embodiment of FIGS. 11 to 13, it can be seen that the seal 201 only differs from the seal 101 of FIGS. 4 to 10, in that the plurality of co-extruded polymeric gripping clips 210 incorporated therein have a single continuous curved hook member 213 which receives and hooks onto a harpoon-shaped end member 209 for fastening each clip 210 to the carrier 205, instead of both hook members 113 of FIGS. 4 to 10 separated by the notch 115 and facing the tongue 116. Exemplary materials for the outer rigid part 211 of clip 210 include plastomers, such as polypropylene-based materials and, for the inner gripping lips 217, a more flexible material such as a thermoplastic one.

In the second variant embodiment of FIGS. 14 to 16, it can be seen that the seal 301 only differs from the seal 201 of FIGS. 11 to 13, in that the plurality of co-extruded gripping clips 310 incorporated therein (which also have as in FIGS. 11 to 13 a single continuous curved hook member 313 which receives and hooks onto a harpoon-shaped end member 309 for fastening each clip 310 to the carrier 305) are not entirely polymeric but a composite made of metal for the outer rigid part 311/polymer for the inner gripping lips 317. Exemplary materials for this metal rigid part 311 include steel, stainless steel or aluminum and, for the polymeric gripping lips 317, a more flexible material such as a thermoplastic one (e.g. PVC) or elastomeric one (e.g. EPDM).

And as shown by FIGS. 4 and 5 and by FIGS. 11 to 16, it is to be noted again that the inventive clips 110, 210, 310 thus post-applied are robust enough to maintain the weather strip seal 101, 201, 301 in the intended design position in all flange thickness conditions including the maximum flange thickness visible in the embodiment of FIG. 5, thanks to the flexibility of the gripping lips 117, 217, 317 combined to the rigidity of the remaining 111, 211, 311 of each clip 110, 210, 310 which keeps the outboard branch 108, 208, 308 of the outer clamping portion 107, 108 or 207, 208 or 307, 308 and thus its lower lip 132, 232, 332 in contact with the surface 104 of the framework 102 (these lips 117, 217, 317 are visible in dotted lines in these Figures to show their initial position before mounting the seal 101, 201, 301 onto the flange 103, and in continuous lines to show their deformed position when mounted on it).

While the invention has been described in connection with specific embodiments thereof, it is evident that many alternatives, modifications, and variations will be apparent to those skilled in the art in light of the foregoing description. Accordingly, it is intended to embrace all such alternatives, modifications and variations that fall within the spirit and broad scope of the appended claims.

1. A weather strip seal for an automotive vehicle which is provided for sealing between a first structure and a second structure made of a vehicle framework having a flange protruding from an adjacent framework surface, the weather strip seal comprising:
a clamping means for clamping on said flange, said clamping means comprising an outer clamping portion having a first branch and a second branch defining together a substantially U-shaped cross-section, and an inner clamping portion incorporating a plurality of separate gripping clips mounted in a spaced relationship along the length of and against said outer clamping portion by an outer part of each clip, and in contact with said flange by inner gripping means of each clip,
a first sealing portion which is designed to sealingly press against said first structure and which extends from said first branch, and
a second sealing portion which is designed to sealingly press against said adjacent framework surface and which extends on said second branch,
wherein each of said gripping clips is made of one piece of different materials comprising, for said outer part, at least one rigid material and, for said inner gripping means, at least one flexible polymeric material.

2. A weather strip seal according to claim 1, wherein said at least one rigid material is based on at least one thermoplastic polymer of the plastomer type, said at least one flexible material being based on at least one elastomer or plastomer, so that each of said gripping clips is entirely polymeric.

3. A weather strip seal according to claim 1, wherein said at least one rigid material is based on a metallic material, said at least one flexible material being based on at least one elastomer or plastomer, so that each of said gripping clips is a composite of metallic and polymeric materials.

4. A weather strip seal according to claim 2, wherein said at least one rigid material is based on a polyolefin which is preferably polypropylene, said at least one flexible material being based on a thermoplastic elastomer which is preferably a thermoplastic vulcanizate (TPV).

5. A weather strip seal according to claim 2, wherein said at least one rigid material comprises polypropylene, said at least one flexible material being based on a thermoplastic elastomer comprising a thermoplastic vulcanizate (TPV).

6. A weather strip seal according to claim 1, wherein said at least one rigid material exhibits a Shore D durometer higher than 30, whereas said at least one flexible material exhibits a Shore A durometer higher than 30.

7. A weather strip seal according to claim 1, wherein said at least one rigid material exhibits a Shore D durometer higher than 60, whereas said at least one flexible material exhibits a Shore A durometer between 50 and 90.

8. A weather strip seal according to claim 1, wherein each of said clips has:
said outer part which substantially exhibits a S-shaped cross-section with a first median leg ending in at least one hook member receiving and hooking onto an end member of said first branch for fastening each clip to it, and with a second leg substantially parallel to said first leg and having an inner surface, and
said inner gripping means which comprise at least one gripping lip obliquely extending from said inner surface of said second leg for gripping a facing surface of said flange.

9. A weather strip seal according to claim 1, wherein said inner gripping means comprise two gripping lips obliquely extending from said inner surface of said second leg for gripping a facing surface of said flange.

10. A weather strip seal according to claim 8, wherein each of said clips is co-extruded and has only one said hook member which is continuous.

11. A weather strip seal according to claim 8, wherein each of said clips has two said hook members connected together by a notch, and wherein a tongue which faces said notch resiliently projects from an inner surface of said first leg to press against said flange opposite said facing surface thereof.

12. A weather strip seal according to claim 1, wherein said first sealing portion comprises at least one primary sealing flocked lip which obliquely extends from said first branch and terminates in a secondary lip directed toward said first branch, and wherein said second sealing portion continuously covers an outer face of said second branch and extends beyond both ends thereof by forming an upper lip which faces said secondary lip and a lower lip designed to sealingly press against said adjacent framework surface.

13. A weather strip seal according to claim 12, wherein said first and second sealing portions are both made of at least one flexible material.

14. A weather strip seal according to claim 12, wherein said first and second sealing portions are both made of at least one flexible material which is the same as that of said inner gripping means and which comprises an elastomeric material based on a thermoplastic vulcanizate (TPV).

15. A weather strip seal according to claim 12, wherein it forms an outer belt strip seal, said first structure being a side window pane of said vehicle and said second structure being a door frame outside said window pane.

16. A weather strip seal according to claim 1, wherein said outer clamping portion is devoid of any metal core.

17. Method for manufacturing a weather strip seal according to claim 1, wherein the method comprises the following steps:
a) forming in one piece said outer clamping portion and said first and second sealing portions,
b) forming in one piece each of said gripping clips, then
c) applying said gripping clips in a spaced relationship inside and along the length of said outer clamping portion.

18. Method for manufacturing a weather strip seal according to claim 17, wherein step b) is carried out by one of the following techniques:
bi-injection molding in a single mold said at least one rigid material and said at least one flexible material,
over-molding said at least one flexible material by injection over said at least one rigid material, or
co-extruding said at least one flexible material and said at least one rigid material.

19. Method for manufacturing a weather strip seal according to claim 18, wherein step b) is carried out by co-extruding said at least one flexible material with said at least one rigid material which is polymeric.

20. Method for manufacturing a weather strip seal according to claim 18, wherein step b) is carried out by co-extruding said at least one flexible material with said at least one rigid material which is metallic.
